(19) United States
(12) Patent Application Publication
(10) Pub. No.: US 2004/0205075 A1
(43) Pub. Date: Oct. 14, 2004

(54) System and method for directing content entry

(76) Inventors: Robert R. LaTurner, Sammamish, WA (US); Scott P. Mills, Sammamish, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/745,346

(22) Filed: Dec. 23, 2003

Related U.S. Application Data
(60) Provisional application No. 60/441,512, filed on Jan. 17, 2003.
(60) Provisional application No. 60/505,017, filed on Sep. 17, 2003.

(51) Int. Cl. G06F 7/00

(52) U.S. Cl. 707/100

(57) ABSTRACT

Embodiments of the systems and methods described herein provide a plurality of entry templates that can be designed to direct and govern potentially unskilled users, clerks, or automated entry processes in the entry and manipulation of content. According to an embodiment, an entry template can include information as to where to store content, how to store content, default values for the actual content and metadata relating to the content, associated additional content, security access to some or all of the same, or any combinations of the foregoing or similar information. According to another embodiment, the entry template may include one or more associated workflow processes such that when content is entered using the template, the workflow processes launch and move the content or related metadata to designated individuals or computer programs for designated actions.

### RELATED APPLICATIONS

This application claims the benefit of U.S. Provisional Application No. 60/441,512, which was filed Jan. 17, 2003 and U.S. Provisional Application No. 60/505,017, which was filed Sep. 17, 2003. This application is being filed concurrently with related U.S. patent application Ser. No. ______, titled “Component Integrator,” Attorney Docket No. FILNTP.388A, and related U.S. patent application Ser. No. ______, titled “System and Method for Accessing Non-compatible Content Repositories,” Attorney Docket No. FILNTP.390A. The foregoing provisional applications and related applications are hereby incorporated in their entirety by this reference.

### BACKGROUND OF THE INVENTION

1. Field of the Invention

The invention relates to system and methods of directing and governing the entry of content.

2. Description of the Related Art

Many organizations use automated tools such as computer applications to manage content. Among such tools are content management systems, business process management systems, web content management systems, and the like. Such systems organize content, categorize content, search for content, process content, and the like. Some content management systems provide additional features beyond managing and organizing content. Business workflow processing systems, for example, in addition to providing general content management, generally move entered content through one or more business or workflow processes. Workflow processes define how content is to be routed to one or more entities, such as computer users or software programs, that may analyze, interpret, edit, or interact with the content in some way. Generally, workflow processes define the specific interactions to be performed by each entity, and the order of that performance.

Many forms of content are particularly amenable to the organization, categorization, searching, processing and the like offered by content management systems because they can be grouped into classes of similar data, such as, for example, insurance claims, invoices, status reports, images, customer feedback, and the like. For example, insurance companies generally provide claim forms requesting content desired for settling insurance claims. A large insurance company may collectively receive content relating to thousands of insurance claims every day. Such recurring transactions lend themselves to the organization and management provided by content management systems, because these transactions require standardized, consistent treatment. Standardized, consistent treatment of content within content management systems aid both human users and automated processes to more effectively use the features of content management systems, such as searching for, finding, and categorizing data.

Additionally, such recurring transactions lend themselves to the automation of business process management systems that can control the routing of content to various appropriate business personnel to ensure complete acquisition of information needed, to estimate a claim's value, to perform fraud checking, or the like. Such automation generally involves custom-programmed applications for teams of personnel having skill levels ranging from straightforward initial content entry to more complicated authorization of claim amounts. In addition to the foregoing, large insurance companies may include different processes for different types of claims. For example, car insurance claims may have different rules and routing than home insurance claims. Custom-programmed applications require skilled programmers to design and maintain, and can be cost prohibitive.

Content management systems fail, however, when content is entered incorrectly, or when it cannot be entered efficiently. When human users or automated processes incorrectly treat similar content differently, such as, for example, by entering the content into a wrong folder or directory, entering the wrong content type for the content, entering the wrong properties, following incorrect entry procedures or protocols, or the like, content management systems lose effectiveness. Content management systems may similarly lose effectiveness when they lack an efficient mechanism for entering recurring content.

As disclosed, the initial entry of content and the initial association of content with specific workflow processes is often accomplished by less skilled or inexperienced workers. These workers or clerks often use judgement in selecting the entry of content and the association of appropriate workflow processes with that content. Thus, traditional content management systems and business process management systems do not provide adequate mechanisms for ensuring repeated organization and entry of similar or identical content, repeated association of appropriate workflow processes, repeated enforcement of content entry restrictions, or the like. Additionally, workflow processes may not provide flexibility in the type of content various personnel are allowed to access. Additionally, traditional content management systems and business process management systems lack tools for quickly designing and implementing directed content entry.

### SUMMARY OF THE INVENTION

Embodiments of the systems and methods described herein provide a plurality of entry templates that can be designed to direct and govern potentially unskilled users or clerks in the entry and manipulation of content. The entry templates may also direct content entry and manipulation by automated processes, such as batch content processors. The entry templates may be quickly designed and implemented.

Directed content entry, as disclosed herein, encompasses but does not require creating content. Directed content entry also includes associating content with properties or metadata that enable the content management system to manage the content. The content itself may be pre-existing content, and may even be content that previously had been stored on the same computer or computer network as the content management system, but which had not yet been managed by the system. Entry templates operate on both newly created and pre-existing content.

According to an embodiment, an entry template can include information as to where to store content, how to store content, a reference or link to the actual content, metadata relating to the content, documents or other attachments for the content, security access to some or all of the same, or any combinations of the foregoing or similar information. According to another embodiment, the entry template may include one or more associated workflow processes such that when content is entered using the template, the workflow processes launch and move the content or related content to designated individuals or computer programs for designated actions. Accordingly, the entry template may advantageously dictate how a clerk or other entity or program interacts with incoming or existing content. Moreover, the entry template may advantageously provide instructions to launch one or more workflow processes associated with particular incoming or existing content, thereby removing or reducing the potential for error and increasing the efficiency of content acquisition.

According to an embodiment, a designer uses a design tool to develop the specific definitions of the entry template that dictate the actions described in the foregoing for content as it is entered into a content management system, workflow processing system, or the like. The design tool may provide a graphical user interface with which a designer may select, in graphical fashion, characteristics of an entry template. In one embodiment, no custom programming to an API is required. A business user that is not a skilled programmer can design entry templates as disclosed. In an embodiment, the design tool may also associate a workflow process from the workflow processing system with a specific entry template. A skilled artisan will appreciate, in light of this disclosure, that the design tool may also associate more than one workflow process with a specific entry template. Alternatively, or in addition, the design tool may include a user interface for developing workflow processes. In any event, the design tool may allow the designer to set some or all properties or definitions associated with the workflow process.

In an embodiment, a clerk uses a content entry tool to associate content with one or more entry templates. Moreover, a clerk may use the content entry tool to launch viewing and/or editing applications to view and/or edit incoming or existing content related to the content. Advantageously, the foregoing entry template may govern the adding, viewing, or editing content or content using the content entry tool. In this way, the centralized entry template ensures that differing clerks or other entities or programs each treat the content in the similar or the same manner, thus providing for consistent content entry and/or manipulation procedures.

In an embodiment, a different entry template may exist or be designed for each unique type of content to be entered. Each entry template may define the unique characteristics of the content to be entered, and may define the unique manner in which the content entry should proceed for each unique type of content. Advantageously, the entry templates therefore may enforce an organization's protocol or procedure for handling various types of content. For example, an insurance company may advantageously use entry templates to ensure that automobile insurance claim information is consistently entered according to one procedure and ensure that homeowners' insurance claim information is consistently entered according to another procedure. Advantageously, this enforced consistent treatment may reduce or eliminate the possibility for human error in following proper content entry procedures.

According to an embodiment, a method of designing an entry template may comprise receiving designer selections for template definitions, optionally receiving designer selections for workflow definitions, and encoding the entry template for storage and use. In an embodiment, the encoding may include encoding a template definition and encoding a workflow definition. In another embodiment, a method of entering content using an entry template may comprise receiving content, receiving an association with an entry template, entering the content and related information according to the entry template, and optionally launching workflow processes associated with the entry template.

The foregoing systems and methods, therefore, may be used to direct content entry, thereby improving consistency, accuracy, and efficiency of the content entry process. In some embodiments, this can be achieved without requiring custom programming by skilled computer programmers. The foregoing systems and methods will now be described in greater detail with reference to the drawings.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a block diagram illustrating an exemplary embodiment of a content management and workflow processing system including one or more entry templates.

FIG. 2 is a flow chart illustrating an exemplary embodiment of a design process for designing the entry templates of FIG. 1.

FIGS. 3A-E are simplified exemplary screen shots illustrating embodiments of a design tool user interface for designing the entry templates of FIG. 1.

FIGS. 4A-C are simplified screen shots illustrating embodiments of a content entry user interface for entering content governed by one or more of the entry templates of FIG. 1.

FIG. 5 is a flow chart illustrating an exemplary embodiment of a content entry process governed by one or more of the entry templates of FIG. 1.

### DETAILED DESCRIPTION OF THE PREFERRED EMBODIMENT

Often, in content processing environments comprising one or more of content management systems, workflow processing systems, web content management systems, or the like, potentially large amounts of content are entered by clerks, other unskilled employees, or automated processes, such as batch content processors. An exemplary environment can include one or more processes, applications, or systems, that govern some or all of: content defining and handling; definable business process execution; security management; versioning; public and private web publication; performance monitoring; replication; storage management; legacy systems compatibility; and the like. In some environments, content may be added, manipulated, modified, and deleted. Additionally, metadata describing and identifying the content, such as for example, an identifier, keywords for searching for the content, a location for the content, information about how, where, when, or by whom content is collected, stored, formatted, and the like may be added, manipulated, modified, and deleted in place of or in addition to the content. For example, the following disclosure includes systems and processes that, in an exemplary embodiment, execute within or in conjunction with content management software commercially available from FileNet Corporation of Costa Mesa, Calif., marketed under the names of “FileNet Business Process Manager,” “FileNet Content Manager,” and “FileNet Web Content Manager,” the details of which are incorporated herein by reference.

“Content” as used herein is a broad term, encompassing all types of content that can be managed by one or more of the foregoing systems as understood by a skilled artisan. Examples of such content include all types of electronic data, including binary data, structured data, such as are stored in databases, unstructured data, such as image documents, folders, word processing documents, CAD/CAM documents, source code files, object code files, web pages, web page descriptions, physical documents, physical objects, and the like. Content management systems are able to manage physical documents and objects not because the physical documents and objects reside within content management systems, but because the content management systems store metadata about the physical documents and objects.

In the foregoing and other processing environments, an entry template as disclosed herein may include information as to where to store content, how to store content, default values for some or all of the content and metadata relating to the content, a reference or link to the actual content, security access rights to some or all of the same, or any combinations of the foregoing or similar information. Design tools and content entry tools can also be used to design and employ the entry templates in an effective manner. For example, an organization can employ such templates to ensure that clerks entering, accessing, viewing, or editing content or metadata do so in an efficient and similar or even same manner. Moreover, the entry template may advantageously provide instructions to launch one or more workflow processes associated with particular incoming or existing content, thereby removing or reducing the potential for error and increasing the efficiency of content acquisition.

To facilitate a complete understanding of the invention, the remainder of the detailed description describes the invention with reference to the figures, wherein like elements are referenced with like numerals throughout.

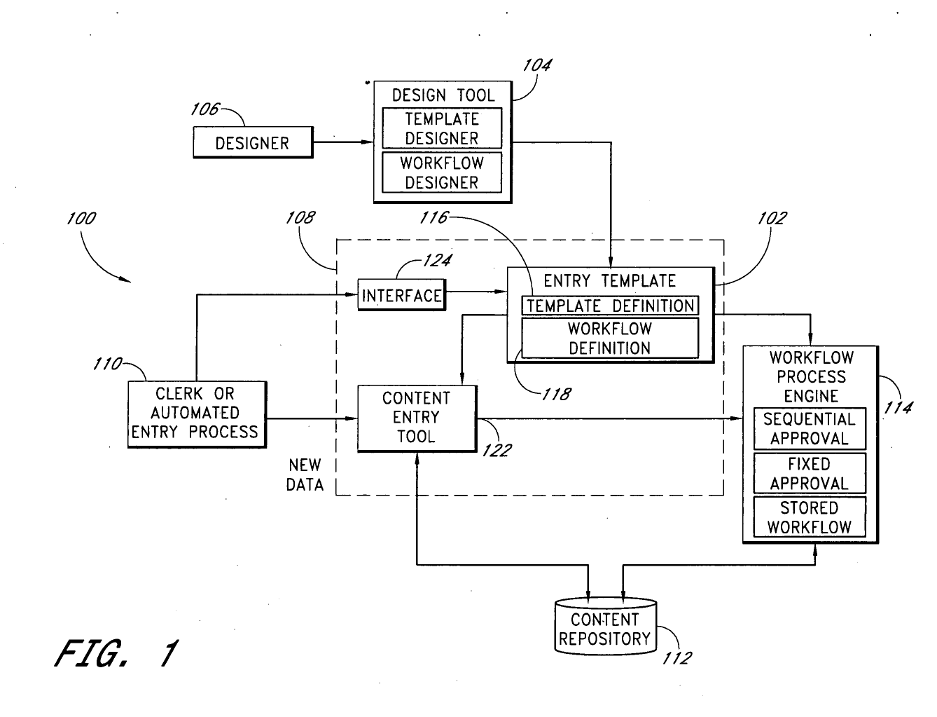

FIG. 1 is a block diagram illustrating an exemplary embodiment of a content management system 100 including one or more entry templates 102. The content management system 100 may be any of the content management systems disclosed, include a general content management system, a web content management system, a business process management system, or the like. As illustrated, system 100 comprises a design tool 104 operated by, for example, one or more designers 106, a content entry system 108 operated by, for example, one or more clerks or automated entry processes 110, generically “entering entities,” and one or more content repositories 112. The content management system 100 may also comprise one or more workflow processing engines 114, such as in the example of a business process management system. According to an embodiment, the entry template 102 includes a template definition 116 and optionally includes an associated workflow definition 118. The template definition 116 comprises encoded information that describes and governs how a clerk or other entity interacts with the content entry system 108 for any content or metadata associated with the particular entry template 102. The optional workflow definition 118 comprises, when the option is taken, encoded information that describes and governs how content or metadata associated with the particular entry template 102 will be routed and manipulated by the associated workflow process.

A workflow process includes its ordinary meaning in the broadest sense and may include a defined series of tasks within an organization to produce a final outcome. Often workflow processes are defined for different types of jobs. For example, in a publishing setting, a document might be automatically routed from writer to editor to proofreader to production. Generally, at each stage in the workflow, one individual or group is responsible for one or more specific tasks. Once those tasks are complete, the workflow process engine ensures that the individuals or programs responsible for the next task are notified and receive the content or metadata they need to execute their stage of the process.

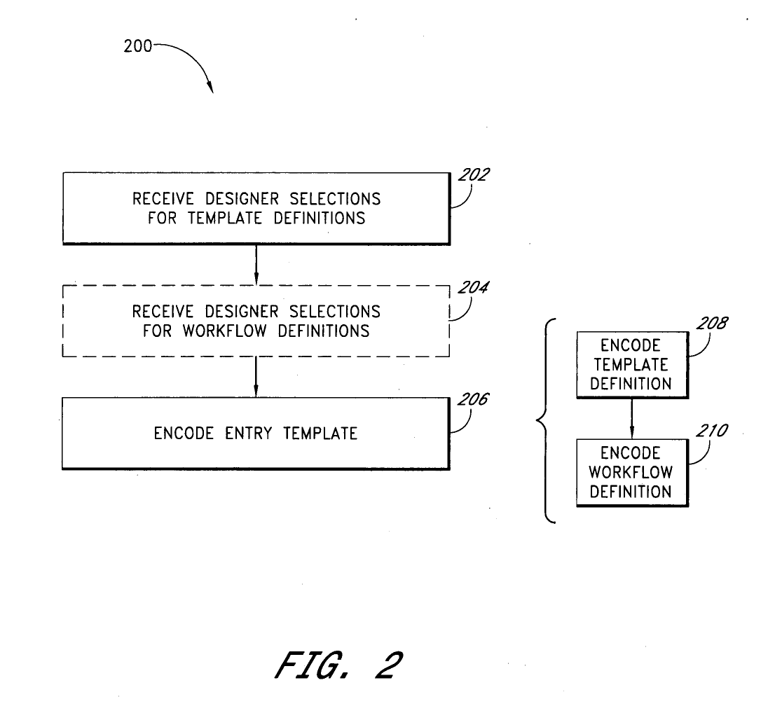

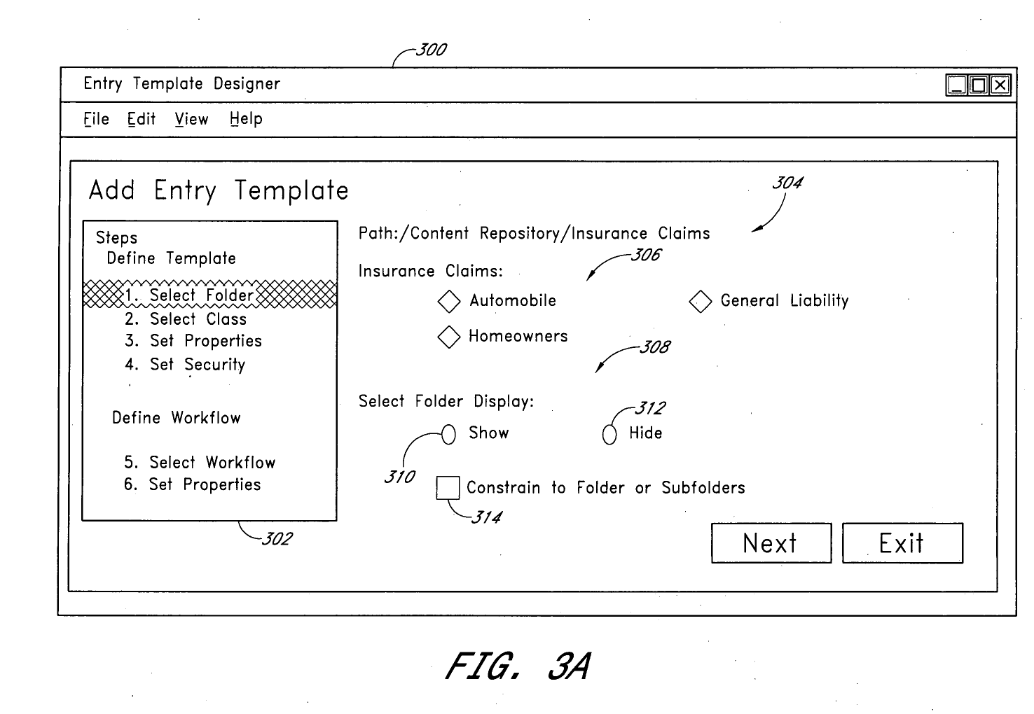

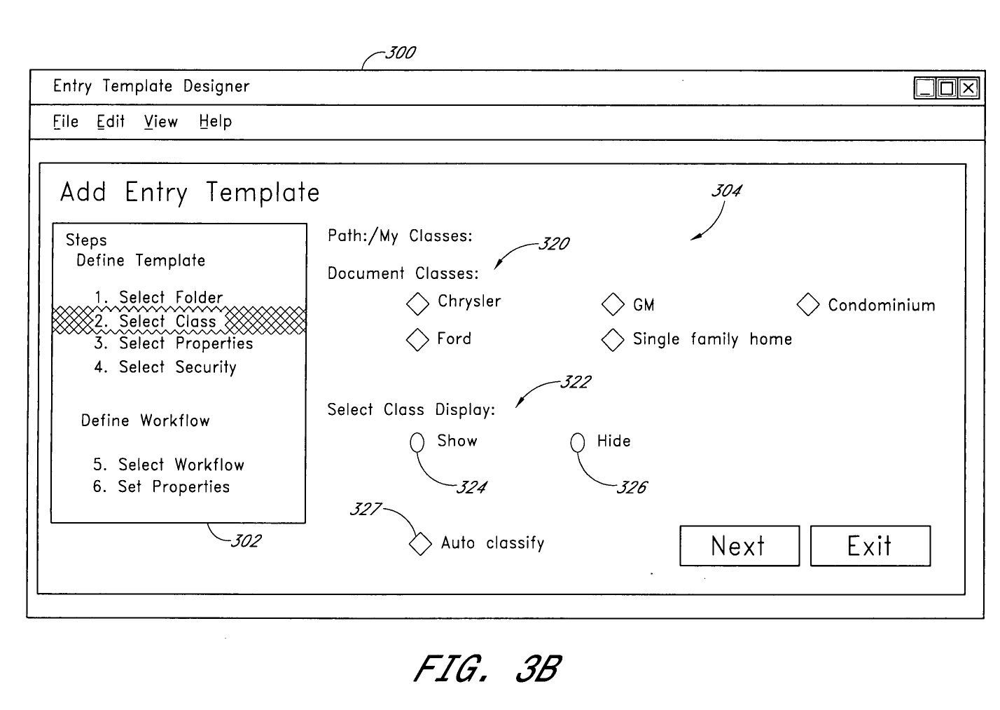

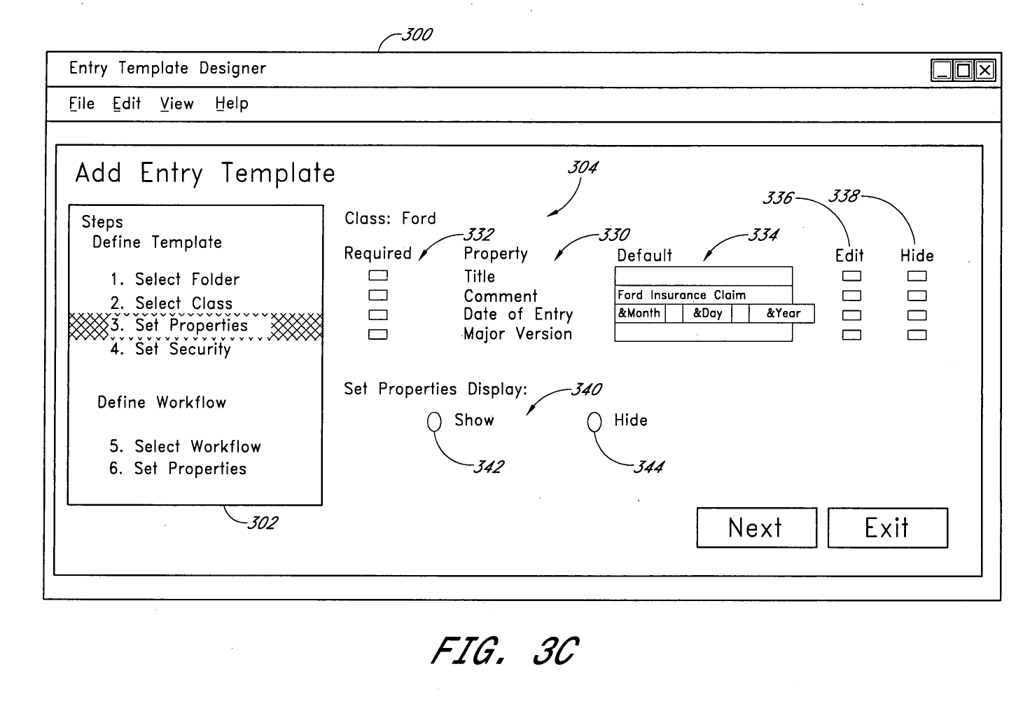

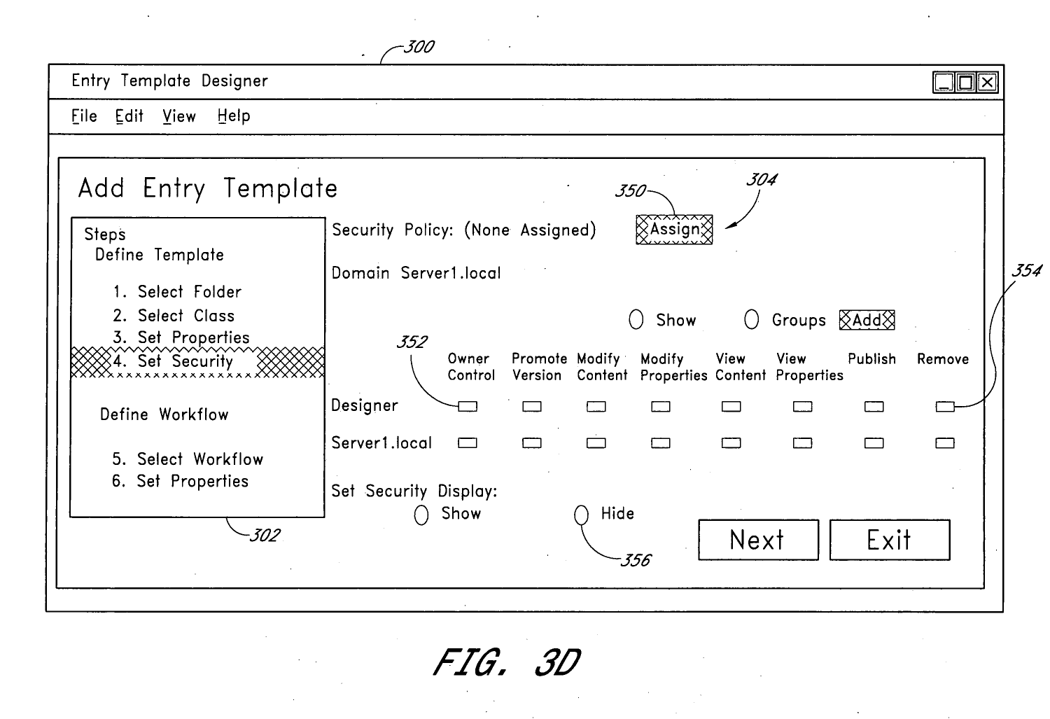

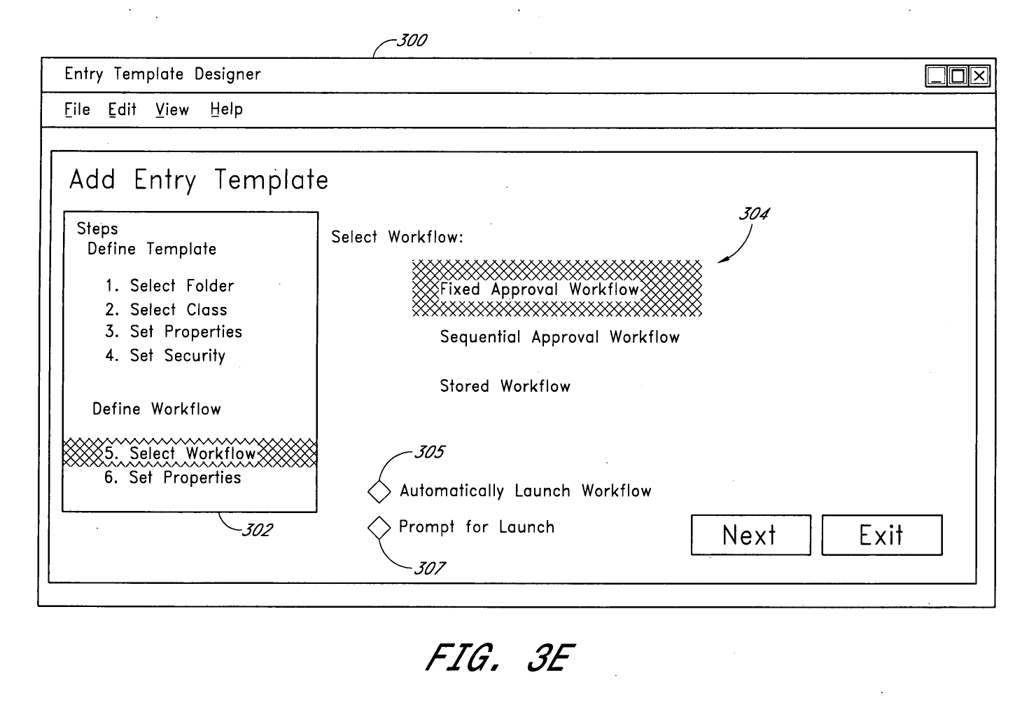

The system 100 also includes a design tool 104, operated by one or more designers 106. According to an embodiment, the design tool 104 includes a graphical user interface for selecting and designing the entry template 102. For example, the design tool 104 may generate one or more ordered displays of properties settable by the design tool 104 depending upon, for example, selections of properties earlier in the order. For example, the design tool may allow for the selection of one or more logical storage locations, such as directories in the content repository 112 for incoming content, and selection of that storage location may dictate later selections, such as subfolders. Additionally, selection of a content object or content class may generate settable and/or customizable property lists based on the selected object or class. One or more exemplary embodiments of the design tool 104 executing a design process will be further disclosed with reference to FIGS. 2-3E.

FIG. 1 also shows the system 100 including the content repository 112. The content repository 112 may include one or more computer accessible content storage systems located in one or more geographic locations accessible over one or more public or private computer networks including the Internet or World Wide Web. The repository 112 includes the broadest meaning of content storage including content stored in caches, memory, hard disks, optical, removable, or other disks or disk systems, database systems, file systems, combinations of the same or the like. The workflow process engine 114 can comprise any commercially available process engine defining actors, such as entities, persons, or programs, assigned to take actions in an ordered manner, such as those process engines commercially available from FileNet corporation of Costa Mesa, Calif., including “FileNet Business Process Manager,” or the like.

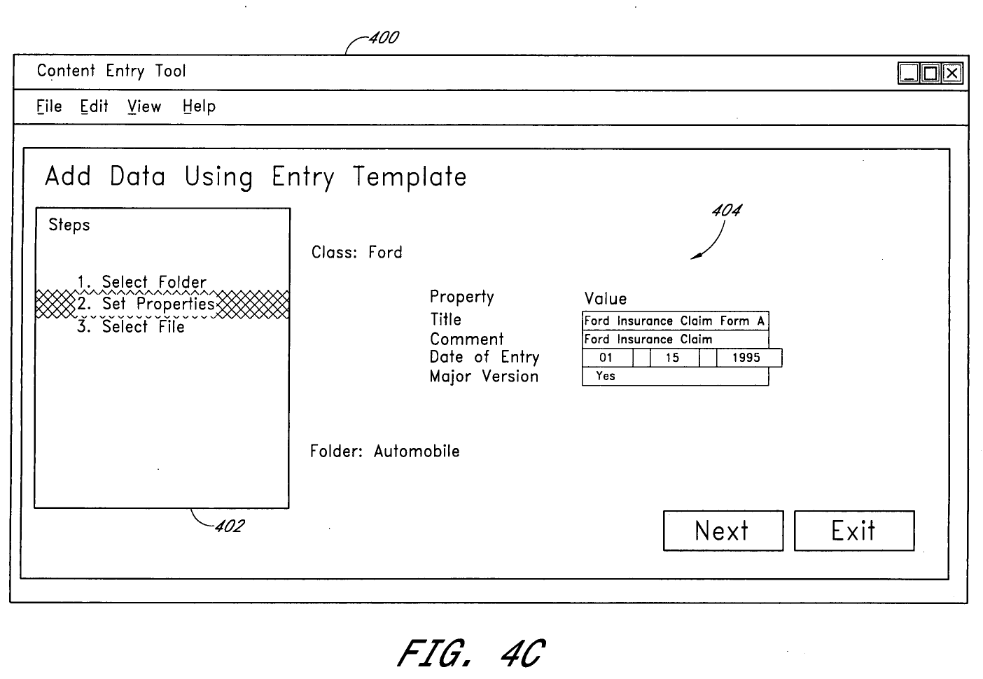

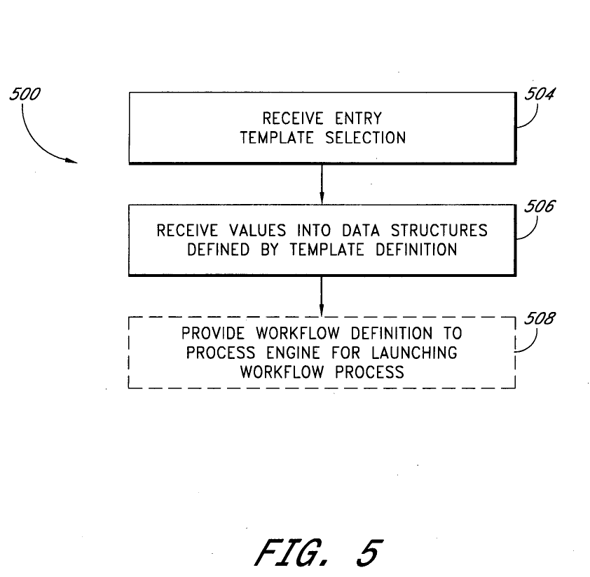

Once the designer 106 uses the design tool 104 to design one or more entry templates 102, the clerk or automated entry process 110 may enter content into the content entry system 108 through, for example, a content entry tool 122. As will be further disclosed with reference to FIG. 5, the content entry tool 122 may launch one or more processes or applications for facilitating the entry of content according to one or more of the entry templates 102. For example, the clerk or automated entry process 110 may acquire content 120 to be entered using the content entry system 108. In an embodiment, the clerk or automated entry process 110 uses the content entry tool 122 to select an appropriate entry template 102 and begins to enter the content 120. When the entry template 102 includes an associated workflow, the content 120 and the associated encoded workflow definition 118 are supplied to, for example, the workflow process engine 114.

Advantageously, the template definition 116 may direct the operation of the content entry tool 122 without requiring any modification of the code of the content entry tool 122. As such, the entry templates 102 may reduce or eliminate customized programming required to alter access restrictions, content formats, entry steps, and like characteristics of the content entry process. Additionally, by using the design tool 104, the designer 106 may advantageously define a directed process for entering content; without writing programming code. Thus, the designer 106 may effectively design an entry template 102 without significant programming ability.

Although disclosed with reference to its preferred embodiment, the disclosure is not intended to be limited thereby. Rather, a skilled artisan will recognize from the disclosure herein a wide number of alternatives for the content entry system 108. For example, the selection of a particular entry template 102 may include using software to review the content and select the appropriate entry template.

FIG. 2 is a flow chart illustrating an exemplary embodiment of a design process 200 for designing the entry template 102 of FIG. 1. In a block 202 of the design process 200, designer selections for the template definition 116 are received. For example, the designer 106 may enter the selections using a graphical user interface provided by the design tool 104, which then receives the designer selections. In an optional block 204, designer selections for the optional workflow definition 118 are received. For example, the designer 106 may enter the selections using a graphical user interface, and the design tool 104 may receive the designer selections. In a block 206, the entry template 102 may be encoded. In one embodiment, the design tool 104 encodes the selections into a descriptive language that describes characteristics of the template definition 116. In one embodiment, the design tool 104 may encode the selections into Extensible Markup Language (“XML”). A block 208 and a block 210 illustrate that the encoding performed in the block 206 may be performed in one or more steps. For example, as illustrated, in the block 208 the template definition 116 may be encoded, while the workflow definition 118 may be encoded in the block 210.

Advantageously, encoding the entry template 102 as a document, such as an XML document, allows the content management system 100 itself to store the entry template 102. As such, entry templates 102 may be categorized, retrieved, processed, sorted, associated with workflow processes, and generally managed by the content management system 100. Advantageously, this allows the content management system 100 to subject entry templates 102 to security and authorization checks so as to, for example, provide restricted access to an entry template 102 to certain users and groups. Additionally, certain entry templates 102, such as those providing an interface to automated processes but not a user interface, may be restricted such that they can be accessed only by the automated processes. Furthermore, entry templates 102 can be added to one or more folders and made accessible, within these folders, to one or more users or groups. Thus, applying the features of the content management system 100 to entry templates 102 generally makes entry templates 102 easier to find, access, use, share, administer, manage, and the like.

FIGS. 3A-E are simplified exemplary screen shots illustrating embodiments of a design tool user interface 300 for designing the entry templates of FIG. 1. As illustrated by FIG. 3A, the design tool user interface 300 comprises generally a content entry step selector 302 and a characteristic or property selection area 304. In one embodiment, as illustrated, a portion of the content entry step selector 302 comprises steps related to defining a template and another portion comprises steps related to defining a workflow process. In general, each step listed on the content entry step selector 302 corresponds to a step that a clerk may typically follow to enter content using the entry template 102. The characteristic selection area 304 may comprise checkboxes, radio buttons, text entry boxes, drop down menus, and any other graphical user interface tool used for entering content, as will be appreciated in light of this disclosure by a skilled artisan. Selections and settings entered by the designer using the characteristic selection area 304 may specifically define how the clerk interacts with each step of the content entry process.

FIG. 3A illustrates in particular a user interface for designing a select folder step. During content entry, a select folder step determines in which folder entered content governed by the resulting encoded entry template is to be stored. In one embodiment, the designer 106 may designate a default folder by selecting a folder from a folder list 306. In one embodiment, the default folder defines a folder in which a clerk enters content using the entry template 102, unless the clerk manually changes the default folder by selecting a different folder. In one embodiment, a select folder display option 308 allows the designer 106 to specify whether a clerk executes the select folder step while using the entry template. If the designer 106 selects a show radio button 310, a clerk does execute the select folder step. If the designer 106 selects a hide radio button 312, a clerk does not execute the select folder step. Advantageously, this allows the designer 106 to designate a default folder that cannot be changed by a clerk. By doing so, the designer may cause all content entered using a particular entry template to be stored in the same folder. Additionally, the designer 106 may check or uncheck a “constrain to folders or subfolders” checkbox 314. If the checkbox 314 is checked, a clerk may, during a select folder step of content entry, browse to find a folder only within the selected default folder hierarchy. Advantageously, this feature may be used to grant a clerk access to a limited range of folders, without granting access to all folders.

FIG. 3B illustrates a user interface for designing a select class step. During content entry, a select class step determines to which class of content the entered content belongs. A content item's class determines characteristics of the content, including, for example, metadata associated with the content. Advantageously, each unique type of content may have a class that defines characteristics unique to that particular type of content. For example, content maintained about Chrysler automobiles may be different from content maintained about Ford or General Motors (“GM”) automobiles. Therefore, as illustrated, content about Chrysler cars may be stored in a “Chrysler” class, content about Ford cars may be stored in a “Ford” class, and content about GM cars may be stored in a “GM” class. Additionally, other classes may pertain to homeowners' insurance claims, such as, for example, single family homes, condominiums, and the like.

In one embodiment, the select class step allows the designer 106 to choose a class from a class list 320. Additionally, the designer 106 may use a select class display option 322 to determine whether or not a clerk has access, during content entry, to the select class step. If the designer 106 selects a “show” radio button 324, a clerk will complete the select class step during content entry. If the designer 106 selects a “hide” radio button 326, a clerk will not complete the select class step during content entry. Advantageously, selecting the “hide” radio button 326 allows the designer 106 to ensure that each content item entered using the same entry template 102 will be of the same class and thus have the same characteristics, ensuring, for example, that content about Ford cars are consistently stored within Ford content classes. In one embodiment, the select class step does not allow the designer to choose a select class display option 322, but only to select a class. According to this embodiment, the clerk or automated process 110 cannot modify the class selection.

Additionally, the designer 106 may select an auto classification feature 327. If the designer selects this feature, then the class will be automatically selected by the content entry system 108 at run-time. In one-embodiment, the content entry system 108 selects a class based on known characteristics of the entered content. For example, certain information contained in the content or the structure of information contained in the content may pertain to one class but not to another.

FIG. 3C illustrates a user interface for designing a set properties step. During content entry, the set properties step guides a clerk through the entry of properties, or metadata, about the entered content. In one embodiment, as illustrated, a list of properties 330 may appear in the characteristic selection area 304 of the design tool user interface 300. In one embodiment, the designer 106 may use required property checkboxes 332 to designate which, if any, properties are required. In one embodiment, a required property is a property that must be entered by a clerk during content entry. In one embodiment, a clerk may not proceed with entering content using an entry template until all required properties have been set. Additionally, the designer 106 may enter default values into default value entry boxes 334. A default value may be an initial value for a property that remains the value unless and until a clerk changes the value. In one embodiment, the designer 106 may specify a code for inserting a default value, such as, for example, the codes entered into illustrated date of entry boxes. The illustrated codes may cause the content entry tool 122 to calculate, for example, the month, day, and year at the time of content entry. Additionally, the designer 106 may specify a content format, such as date, string, integer, or the like, for a property.

The designer 106 may use “edit property” checkboxes 336 to designate which, if any, properties may be edited by a clerk. By unchecking the “edit property” checkbox 336 for a property with a default value, the designer 106 may force a content item added with the entry template to have the default property value. Additionally, the designer 106 may use “hide property” checkboxes 338, to designate which, if any, properties are to be hidden from the content entry clerk. Advantageously, the set properties display option 340 allows the designer 106 to include or exclude the set properties step in the content entry steps completed by a clerk. If the designer 106 selects a “show” radio button 342, the set properties step may be included in the content entry process. If the designer 106 selects a “hide” radio button 344, the set properties step may be excluded from the content entry process. Advantageously, this allows the designer 106 to streamline content entry for cases in which default values suffice for all properties, and are not meant to be changed. In one embodiment, in which major and minor versioning are supported, the designer 106 may designate whether the entered content is a major or a minor version. According to an embodiment, content that is designated a major version may receive a different level of treatment than does content that is designated a minor version. For example, content that is a minor version may be internal content, and not accessible outside a department or organization. Content that is a major version may be accessible to the public, such as for example, web site content that has been approved by a person reviewing it. Versioning enables a straightforward way to provide at least two levels of treatment for content. A skilled artisan will appreciate, in light of this disclosure, that any number of different types of treatment of content may be triggered according to whether the content is a major or minor version, such as, for example, security settings, access restrictions, ability to edit the content, order of listing of the content in, for example, search results, and the like.

In one embodiment, as illustrated, the list of properties is determined by the class that has been selected. Properties may therefore be added or deleted for a class by modifying a class definition. Additionally, in one embodiment, the designer 106 may add properties using the design tool user interface 300. In light of the foregoing, a skilled artisan will appreciate that any number and type of properties may be defined. In this regard, the properties listed in the property list 330 of FIG. 3C, including Title, Comment, Date of Entry, and Major Version, are exemplary only.

FIG. 3D illustrates a user interface for designing a set security entry step. During content entry, the set security entry step allows a clerk to set various access permissions. The permissions may be set on a user level, a group level, or both. In one embodiment, the designer 106 may select an assign security policy button 350 to assign a security policy with preset access permissions. Examples of such security policies may include private, internal use only, confidential, public, and the like. A skilled artisan will appreciate that each security policy defines a differing level of access to particular content. A security policy may also be defined in terms of certain users' roles in the data entry process, such as author, reviewer, publisher, and the like. For example, one security policy might allow only an author to edit content, while another policy might allow reviewers and publishers to edit content. Additionally, the designer 106 may use “access permission” checkboxes 352 to designate which users or groups have specific levels of access to the content. Specifically, in one embodiment, the designer 106 may allow or deny a user or group owner control over the content, or grant or deny permissions for each user or group to promote the version of the content, modify the content, modify the properties, view the content, view the properties, publish the content, or the like. An additional “remove” checkbox 354 allows the designer 106 to completely remove a user or group from the access permissions list. In one embodiment, as illustrated, the designer 106 may exclude the set security step from the entry template by selecting a “hide” set security 356 radio button. This advantageously allows the designer 106 to streamline the content entry process for cases in which default security settings are sufficient. Additionally, this feature prevents a clerk 110 from making errors in setting security permissions.

FIG. 3E illustrates a user interface for associating a workflow with an entry template. As illustrated in FIG. 3E, the design tool 104 allows the designer 106 to select a “Fixed Approval Workflow,” a “Sequential Approval Workflow,” or any stored workflow process that has been designed by a separate workflow process design tool. (The workflow process design tool is not shown.). By selecting a workflow process, associated with the process engine 114, the designer 106 designates a default workflow process to be loaded by the content entry tool 122 into the workflow process engine 114 upon completion of content entry. By selecting an “automatic launch” selector 305, the designer 106 chooses to have the content entry tool 122, upon completion of data entry steps by the clerk or automated entry process 110, cause the workflow process engine 114 to launch the workflow process automatically. By selecting a “prompt for launch” selector 307, the content entry tool 122 prompts the clerk or automated entry process 110 to manually launch the workflow process, and launches the workflow process only when the clerk or automated entry process does launch the workflow, such as, for example, by clicking on a launch button or link.

In one embodiment, a “Fixed Approval Workflow” and a “Sequential Approval Workflow” are each straightforward workflow processes that can be designed using the workflow designer within the design tool 104. In general, a Fixed Approval Workflow defines steps in which content is reviewed by reviewers, then approved by approvers, then optionally published by optional publishers. Typically, such a workflow process may operate thusly: when a workflow process is launched with given content, some or all of the content may be routed to each reviewer on the reviewers list. The reviewers then may accept or reject the content. If the reviewers accept the content, the content may be routed to the approvers, who may accept or reject the content. If the approvers accept the content, the content may be routed to the publishers, who may accept the content and pass it to publication, or may reject the content. In one embodiment, such a workflow also includes an editing step, which may occur when one of the participants, such as a reviewer, an approver, or a publisher, rejects the content or desires to change the content in some way. For example, if an approver wants content changed, the approver may invoke the edit step in order to edit the content. Additionally, the approver may reject the content, causing the content to be routed back to the reviewers for further editing. In one embodiment, a “Sequential Approval Workflow” defines a workflow process in which content is routed to one or more groups of participants in a particular sequence, where the number of groups of participants may be defined by the designer 106.

The designer 106 may, using the design tool user interface 300, associate content fields with the workflow process. Similarly, the designer may associate additional content with the workflow process that participants in the process may view or manipulate, such as, for example, images, forms, documents, and the like. The designer 106 may assign a particular content type to each content field. Additionally, the designer 106 may add or remove content fields and add or remove attachments. Moreover, the designer 106 may associate participants to a workflow process. Participants may be users or automated programs that complete one or more of the steps of a workflow process. For example, with regard to the fixed approval workflow example, the designer 106 may assign certain participants to be reviewers, other participants to be approvers, and other participants to be publishers. One or more users may participate in each step, and each participant may participate in one or more steps. The designer 106 may select which step to associate participants with and select each associated participant from a list of possible participants. Additionally, for each step, the designer 106 may designate content fields and/or attachments that are accessible to the participants of that step. Advantageously, this capability allows the designer 106 to design a workflow process that grants access to none, some, or all content to a specific participant. Such access may be granted on an individual level. Advantageously, this allows the workflow processes defined within an entry template to direct content entry such that each participant receives only that content that will be useful for that participant.

Typically, a workflow process may execute under a rule that all participants at a given level must approve content before the content advances to the next level. Alternatively, a workflow process may execute under a rule that content may advance a level if a given number of participants approve, even when not all participants approve. This rule defining approval of content may be termed “voting approval routing.” In one embodiment the designer 106 may toggle voting approval routing by checking a checkbox and entering a number of participants, or votes, required for approval. In one embodiment, the number of participants required for approval need not be a majority of participants.

In one embodiment, the designer 106 may allow each participant of a given step to delegate the participant's responsibilities with regard to the step to another user. When such delegation, or reassignation is allowed, User A may, for example, reassign the step to User B. In such a case, User B would perform User A's duties, and, for example, if User B approved the content, User B's approval would count as if it were the approval of User A.

In one embodiment, the designer 106 may establish a deadline by which each participant must complete a step. In one embodiment, such a deadline may trigger a reminder to a participant that is running up against the deadline. Additionally in such a case, a deadline may cause a notification message to be sent to another participant, such as, for example, the assigned participant's supervisor. Other responses to tight deadlines may be triggered as well, as will be understood by a skilled artisan in light of this disclosure.

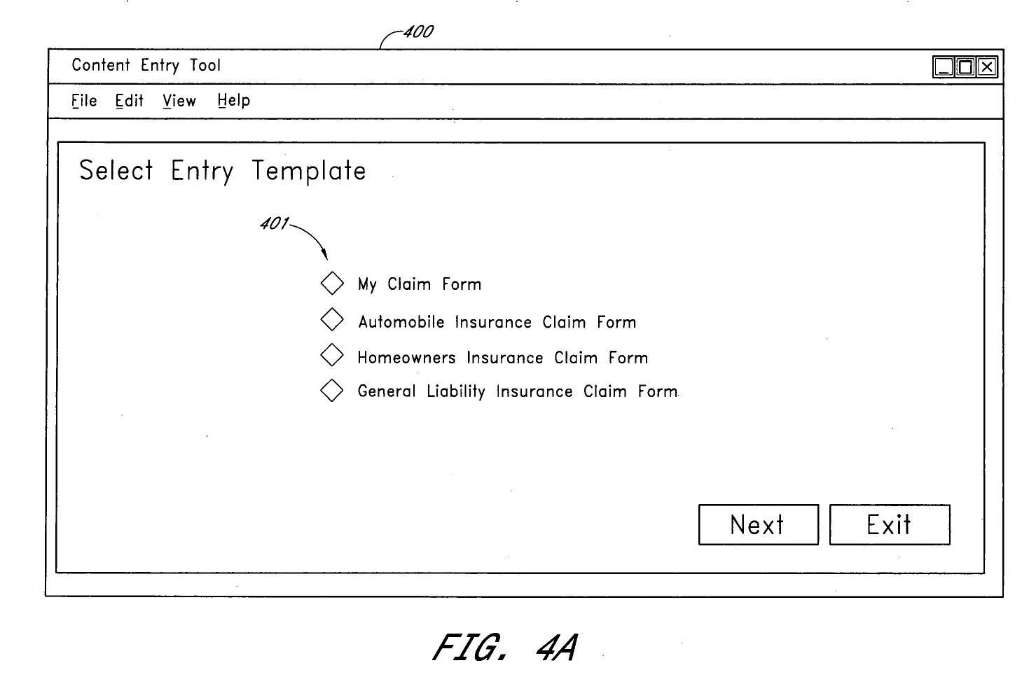

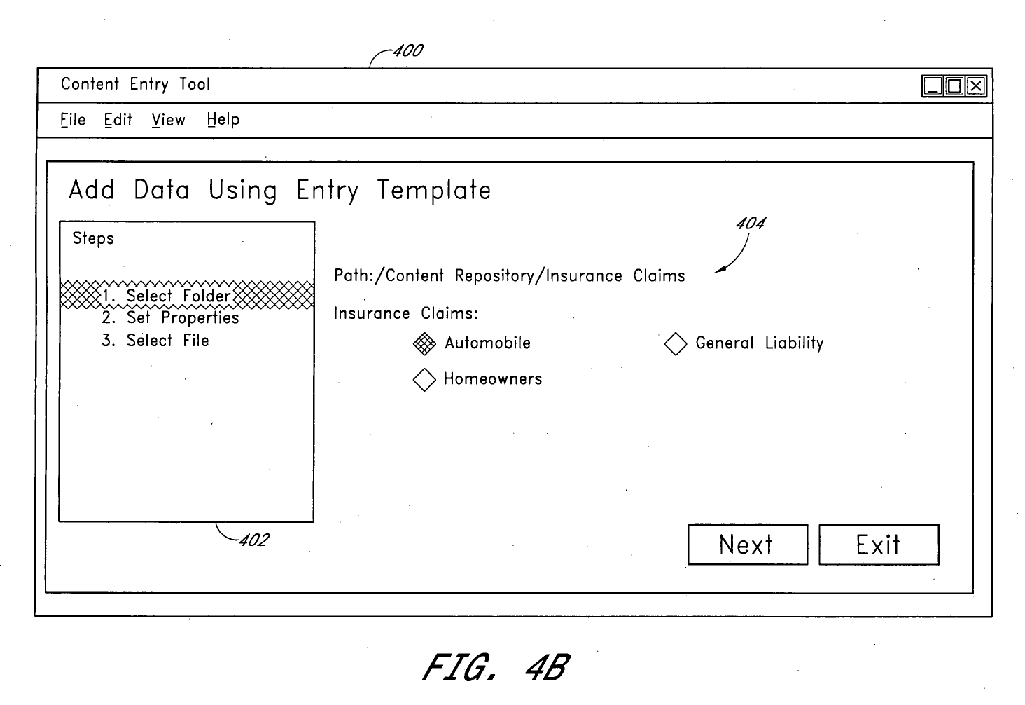

FIG. 4A is a simplified screen shot of a content entry tool user interface 400 for selecting an entry template 102 to direct data entry. As illustrated, the content entry tool user interface 400 comprises an entry template list 401. According to an embodiment, the clerk 110 may select an entry template 102 from the list. In one embodiment, upon selection, the selected entry template 102 is launched. As indicated by their exemplary names, the illustrated entry templates 102 are designed to enter a particular type of content, such as, for example, automobile insurance claim forms, homeowners' insurance claim forms, and general liability claim forms. As has been described, each of these forms have different metadata associated with them, should be entered according to different steps, may have different workflows associated with them, and the like. As illustrated, a clerk 110 may make a straightforward choice, driven by descriptive entry template names, without necessarily knowing anything about the underlying entry process enforced by each entry template 102.

Additionally, FIG. 4A illustrates a generic entry template labeled “My claim Form.” In one embodiment, more than one entry template 102 may share a descriptive name. “My claim Form,” for example, may be displayed on each clerk's entry template selection list 401, but each clerk 110 may, in practice, execute a different entry template 102 by selecting “My claim Form.” The content entry system 108 may determine which entry template 102 to run based on characteristics of the user selecting the entry template name, characteristics of the accessing computer, characteristics of a department, within an organization in which the entry template has been selected, and the like. For example, each clerk at an insurance company may select a “My claim Form” entry template and the content entry system 108 may automatically select an entry template to run based on the clerk's position in the company. A clerk that handles automobile insurance claims, for example, would invoke the “Automobile Insurance claim Form.” Advantageously, this feature allows an organization to design entry templates 102 with common names, while still preserving an ability to provide different direction for content entry processes depending on the context of the use of the entry template 102. Features of the content management system 100, such as, for example, security and access control features, may be used to ensure that each clerk or automated entry process 110 accesses an entry template 102 associated with the clerk or automated entry process 110.

FIGS. 4B-C are simplified screen shots of a content entry tool user interface 400 for entering content using an entry template of FIG. 1. As illustrated on FIG. 4B, the content entry tool user interface 400 may comprise a list of content entry steps 402 and a content entry area 404. In general, the steps listed on the list of content entry steps 402 correspond to the steps that the designer 106 did not “hide” using the design tool 104. For example, as illustrated, the designer 106, in this example, chose to “show” the select folder step and the set properties step but chose to “hide” the select class and set security steps. Additionally, as illustrated, a select file step may appear on the list of content entry steps 402. This step may occur even when not part of the design process, and allows a clerk or automated entry process to associate a content file with the content entered using the entry template. The “select file” step, not illustrated, may employ any graphical user interface device for selecting a file, such as a text selection box, a browse functionality, a drop-down menu, or the like.

As illustrated, FIG. 4B illustrates the select folder step. In one embodiment, the clerk or automated entry process 110 may select a folder in which to store the entered content. In one embodiment, the default folder selected by the designer 106 may initially be selected, but the clerk or automated entry process 110 may change this default. As illustrated, FIG. 4C illustrates the set properties step. Comparing FIG. 4C with FIG. 3C, it is apparent that the set properties step is driven by the design of this step. For example, as illustrated, the Comment “Ford Insurance claim” is the default value for this field, as illustrated in FIG. 3C. In one embodiment, the clerk or automated entry process 110 may change any default values and any other value, so long as the property has been designated as editable during the design process.

FIG. 5 is an exemplary flow chart illustrating one embodiment of a content entry process 500 driven by the entry templates 102 as disclosed herein. In a block 504, an entry template selection is received. In one embodiment, the content entry system 108 receives an entry template selection from the clerk or automated entry process 110. Furthermore, the content entry system 108 may associate the content with an entry template selected by the clerk or automated entry process 110. In a block 506, values may be received into data structures defined by the template definition 116. In one embodiment, the values are received for each property, security setting, folder, class, and the like that is defined by the entry template 102. In an optional block 508, the workflow definition 118 is provided to the workflow process engine 114 for launching the workflow process 118 associated with the content. In one embodiment, workflow participants, if any, may be designated just prior to launching any workflow processes.

As indicated, the directed data entry process governed by entry templates 102 as disclosed herein may be invoked by clerks of automated entry processes 110. With regard to automated entry processes 110, a batch content processor, such as, for example, an optical character recognition scanner, may receive a large number of paper documents. The batch content processor may scan those documents, creating electronic content. Additionally, the batch processor, upon creating each item of electronic content, may be configured to communicate with a software interface to the particular entry template 102 that it wishes to invoke. According to one embodiment, each entry template 102 has a custom API to facilitate such interaction with batch processes. According to one embodiment, the batch processor is configured to transmit parameters to the interface that indicate an entry template selection, values to enter into the entry template, and the location of the electronic document. The interface may enter the transmitted parameters using the specified entry template.

In one embodiment, a batch content processor may detect which entry template to invoke, such as, for example, by scanning a bar code on a paper document. Additionally, the batch content processor may, through optical character recognition, detect characteristics of a paper document. In one embodiment, a batch processor receives content by email. Upon receiving each email, the batch processor invokes an entry template for entering content attached to the email. A skilled artisan will appreciate, in light of this disclosure, that any number of mechanisms for processing a large amount of content in batch can be employed, such as, for example, web sites that capture user input, touch tone telephone signal readers, facsimile machines, and the like.

A skilled artisan will appreciate, in light of this disclosure, other embodiments for making and using entry templates as described herein. For example, the entry template 102 can be used to design a custom user interface, for example, for an electronic form. All such embodiments are intended to be within the scope of this disclosure. The inclusion in this disclosure of any particular embodiment does not limit the invention to that embodiment. Nothing in this disclosure limits the invention. The claims alone, and nothing else, define the scope of the invention.

What is claimed is:

1. A content entry system for directing one or more entering entities to consistently enter content usable by at least one of a content management system and a workflow processing system, the content entry system comprising:
at least one entry template including a template definition and capable of including a workflow definition; and
a software interface usable by one or more entering entities to enter a plurality of content according to the template definition and, when included, to forward the workflow definition and at least a portion of the plurality of content to a workflow process engine,
wherein the software interface accesses the template definition to configure at least a portion of input screens to supply default configurations thereby providing consistent content entry by the one or more entering entities for the plurality of content.

2. The content entry system of claim 1, wherein the template definition configures the input screen of the software interface used by the entering entity to make inaccessible to the entering entity at least a portion of the default configurations.

3. The content entry system of claim 1, wherein the template definition configures the input screen of the software interface used by the entering entity to supply default content describing at least a portion of the plurality of content.

4. The content entry system of claim 1, wherein the template definition configures the input screen of the software interface used by the entering entity according to security authorizations associated with the entering entity.

5. The content entry system of claim 1, wherein the template definition configures the input screen of the software interface used by the entering entity based on a class of content to which the plurality of content belongs.

6. The content entry system of claim 5, wherein the template definition configures the input screen of the software interface used by the entering entity based on properties associated with the class.

7. The content entry system of claim 1, wherein a designer uses a design tool to select at least some of the default configurations.

8. The content entry system of claim 1, wherein at least some of the plurality of content is stored in a content repository.

9. A system for directing content entry, the system comprising:
a group of constraints that govern the entry of content;
a plurality of workflow content identifying one or more workflow processes that define one or more steps for processing at least some of the content and each step defines one or more participants that participate in the processing of that content;
a design tool which allows user configuration of the group of constraints and associates the plurality of workflow content with the group of constraints; and
a content entry tool which accesses the group of constraints and governs the entry of content according to the group and which forwards at least some of the content and the plurality of workflow content to a system for executing workflow processes.

10. The system of claim 1, wherein the group of constraints include at least a number of fields that must be filled out during the entry of the content.

11. The system of claim 10, wherein the group of constraints further define a format for the fields.

12. The system of claim 1, wherein the group of constraints include at least a restriction on a entering entity's ability to enter the content.

13. The system of claim 1, wherein the group of constraints include at least a restriction on a entering entity's ability to alter defaults supplied as a part of the group of constraints.

14. The system of claim 1, wherein the group of constraints include at least a restriction on a entering entity's ability to view the content.

15. The system of claim 1, wherein the group of constraints are encoded using a description language.

16. The system of claim 15, wherein the description language is XML.

17. A method for defining a template definition of an entry template comprising:
receiving first selections on where to store incoming content, how to enter incoming content including at least some default entries, and metadata relating to the incoming content;
receiving second selections on a step-by-step process for reviewing, modifying, or otherwise acting on the entered content, wherein each step specifies one or more participants that perform the reviewing, modifying, or acting; and
converting the first and second selections into an encoded entry template usable to configure the intake of content by a content management system according to the first selections and usable to configure a workflow processing system according to the second selections.

18. The method of claim 17, wherein the converting includes encoding a template definition and a workflow definition using a description language.

19. The method of claim 17, wherein the template definition can be designed without custom programming to an API and without requiring the definer to be a skilled programmer.

20. The method of claim 18, wherein the description language used is XML.

21. A method for directing the entry of content, comprising:
associating content of a specific data classification with an entry template;
based on the associated entry template, creating a content object that has characteristics defined by the entry template; and
based on the content, recording values of parameters defined by the entry template into the content object.

22. The method of claim 21, further comprising launching a workflow process specified by the entry template.

23. The method of claim 22, wherein launching the workflow process includes automatically launching the workflow process.

24. The method of claim 22, wherein launching the workflow process includes launching the workflow process in response to a request from an entering entity.

25. The method of claim 22, wherein the workflow process defines, for each step of the workflow process, one or more workflow participants that are able to view or modify the content.

26. The method of claim 24, wherein the entry template restricts at least one of the workflow participant's ability to view or modify at least a portion of the content.

27. An entry template for use in a content management system, comprising:
an encoded definition of a plurality of steps for entering content into a content management system;
an encoded definition of a plurality of properties to be associated with at least some of the content to the content management system; wherein the encoded definition of steps and the encoded definition of the plurality of properties cooperatively are configured to be accessed by a content entry program module and to cause the content entry program module to direct content entry into the content management system according to the encoded definitions.

28. The entry template of claim 27, further comprising an encoded definition of a workflow process, describing at least by reference, a workflow process including a step-by-step process for further manipulation of the entered content, configured to be received by the content entry program module and to cause the content entry program module to perform further manipulation of the entered content according to the encoded workflow definition.

29. The entry template of claim 28, further comprising an encoded definition describing at least one access restriction, configured to be received by the content entry program module and to cause the content entry program module to prevent at least one content entry participant from viewing at least a portion of the content.

30. The entry template of claim 28, further comprising an encoded definition describing at least one access restriction, configured to be received by the content entry program module and to cause the content entry program module to prevent at least one content entry participant from modifying at least a portion of the content.
